(19) United States
(12) Patent Application Publication
(10) Pub. No.: US 2013/0182291 A1
(43) Pub. Date: Jul. 18, 2013

(54) INFORMATION PROCESSING APPARATUS, IMAGE FORMING APPARATUS AND SYSTEM

(71) Applicants: KABUSHIKI KAISHA TOSHIBA, Tokyo (JP); TOSHIBA TEC KABUSHIKI KAISHA, Tokyo (JP)

(72) Inventor: Yuta Kawai, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/742,798

(22) Filed: Jan. 16, 2013

Related U.S. Application Data
(60) Provisional application No. 61/587,198, filed on Jan. 17, 2012.

(51) Int. Cl. G06K 15/02

(52) U.S. Cl. CPC G06K 15/1889
USPC 358/3.28

(57) ABSTRACT

In accordance with an embodiment, an information processing apparatus comprises a storage unit, a display unit, an input unit and a control unit. The storage unit stores a ground pattern. The display unit displays the image of an object to be printed. The input unit acquires a range information representing partial area of the image displayed by the display unit. The control unit adds the ground pattern stored in the storage unit to the area of the image and generates a printing data of the image based on the range information acquired by the input unit.

### CROSS-REFERENCE TO RELATED APPLICATIONS

This application is based upon and claims the benefit of priority from U.S. Provisional Application No. 61/587,198 filed on Jan. 17, 2012; the entire contents of which are incorporated herein by reference.

### FIELD

Embodiments described herein relate to a technology for adding a ground pattern to a sheet.

### BACKGROUND

There is an image forming apparatus which prints the image data of an object to be printed after adding a ground pattern to the image data. There is also an image forming apparatus capable of determining, using a ground pattern, whether or not to output drawn images in pages when printing a sheet added with the ground pattern.

However, as the conventional image forming apparatus makes the determination above by taking page as the unit, even if a page added with a ground pattern can be partially disclosed, the information that can be disclosed is not output.

### BRIEF DESCRIPTION OF THE DRAWINGS

FIG. 1 is a diagram showing an example of the structure of an image forming system.

FIG. 2 is a diagram showing an example of the structure of an image forming apparatus.

FIG. 3 is a flowchart exemplarily illustrating the action of forming a sheet partially added with a ground pattern according to an embodiment.

FIG. 4 shows an example of an operation screen for setting the position and the range of a ground pattern.

FIG. 5 is a diagram exemplarily illustrating the action of outputting a sheet partially added with a ground pattern.

FIG. 6 is a diagram exemplarily illustrating the action of outputting a sheet partially added with a ground pattern (having a level setting).

FIG. 7 is a diagram showing an example of a system provided with a plurality of image forming apparatuses.

### DETAILED DESCRIPTION

In accordance with an embodiment, an information processing apparatus comprises a storage unit, a display unit, an input unit and a control unit. The storage unit stores a ground pattern. The display unit displays the image of an object to be printed. The input unit acquires a range information representing partial area of the image displayed by the display unit. The control unit adds the ground pattern stored in the storage unit to the area of the image and generates a printing data of the image based on the range information acquired by the input unit.

The following embodiments are described in the following forms.

1. In the case where a ground pattern is added when an image is formed on a sheet, the ground pattern is only added to the part of a page desired to be prohibited (a part unseen to the other people) but not to the whole page.

2. In the case where a Job ‘copy’/‘scan’/‘send FAX’ is carried out for a sheet partially added with a ground pattern, the reading position of the ground pattern is deleted or hided out while the other positions are kept.

3. A plurality of ground patterns are prepared, a user authority is pre-assigned corresponding to each ground pattern, and a processing corresponding to a user authority is carried out.

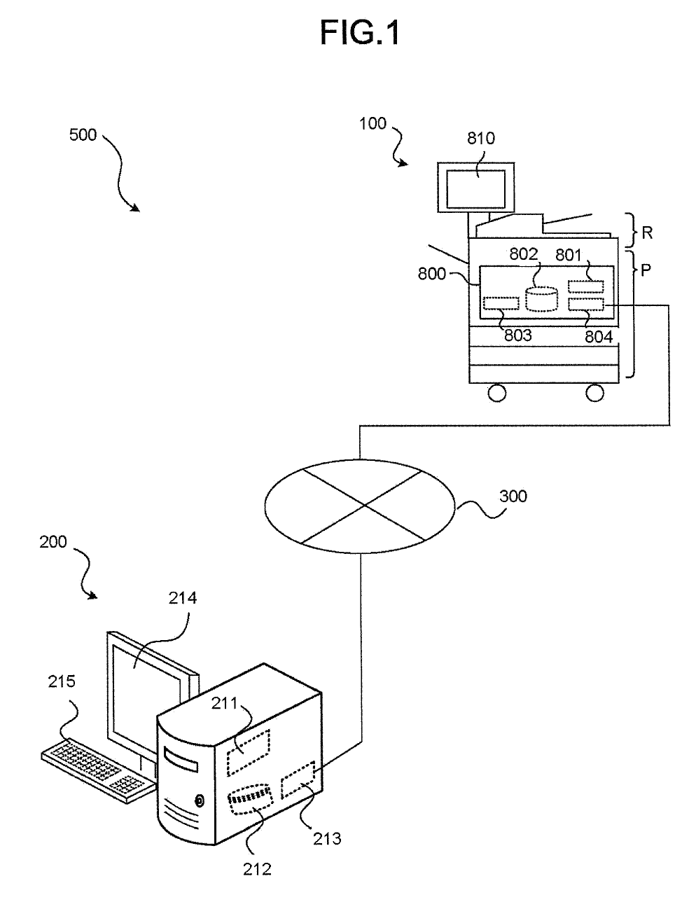

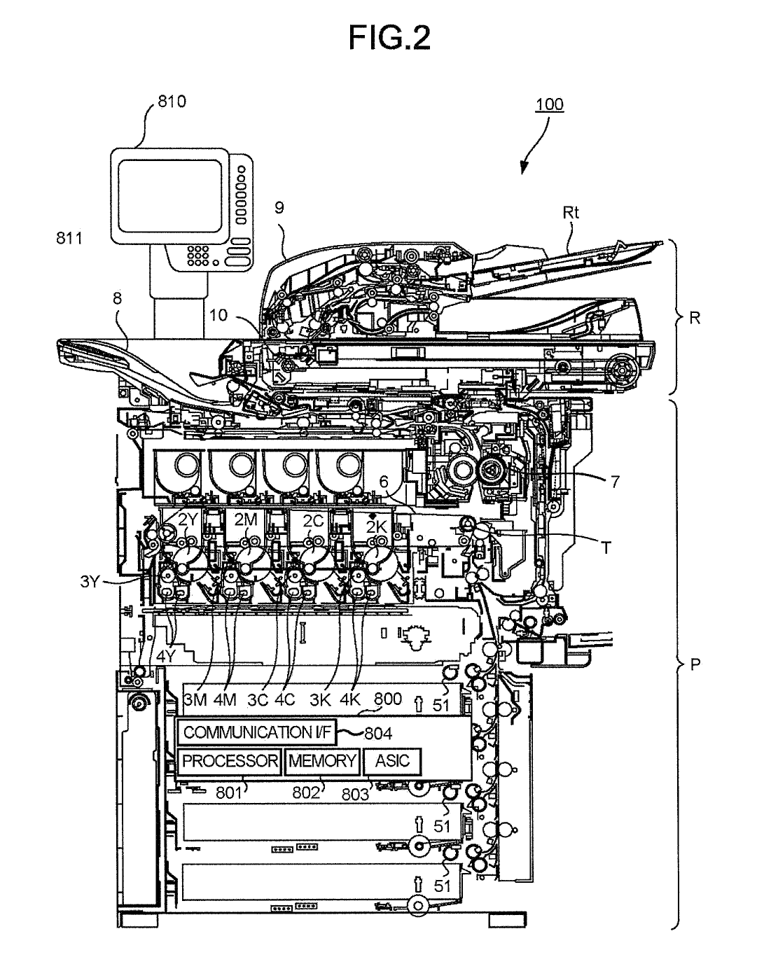

The form of the embodiment is described below with reference to accompanying drawings. FIG. 1 is a schematic diagram showing an example of the structure of an image forming system according to the embodiment, and FIG. 2 is a diagram showing the longitudinal section of an exemplary structure of an image forming apparatus.

As shown in FIG. 1, an image forming system 500 connects an image forming apparatus 100 with a computer 200 through a network 300. The image forming apparatus 100 is an MFP (Multi Function Peripheral) provided with a reading unit R and an image forming unit P. Moreover, the image forming apparatus 100 has a control board 800 for comprehensively controlling each piece of hardware in the image forming apparatus. The control board 800 comprises a processor 801, a memory 802, an ASIC 803 (Application Specific Integrated Circuit) and a communication I/F 804 (I/F Interface). The processor 801 is an operation processing apparatus such as a CPU (Central Processing Unit) or an MPU (Micro Processing Unit). The processor 801 has a function of realizing various processing in the image forming apparatus 100 and achieves various functions by loading and executing the program pre-stored in the memory 802.

The memory 802 is a memory unit consisting of nonvolatile memory apparatuses including an RAM (Random Access Memory) serving as a primary memory apparatus, a flash memory and a hard disk drive. The ASIC 803 is an integrated circuit for specializing an image processing. The communication I/F 804 is a unit comprising a FAX board connected with a public line and an LAN (Local Area Network) board connected with the network 300.

Further, the image forming apparatus 100 has a control panel 810 which is provided with a touch panel type or keyboard type input unit for accepting the instruction of the user. Besides, the control panel 810 has a flat plate type display (display unit) for displaying the content or information being processed for the user.

The computer 200 comprises a processor 211 having the same function with the image forming apparatus 100, a memory 212, a communication I/F 213, a monitor 214 functioning as a display unit and a keyboard 215 functioning as an input unit. The input unit may also be provided with a mouse. The communication I/F 213 transmits data with the communication I/F 804 of the image forming apparatus 100. Moreover, a print driver (program) which is read when the image forming apparatus 100 carries out a printing operation is imported into the memory 212 in advance.

The image forming apparatus 100 is described in detail below with reference to FIG. 2.

The reading unit R, which has a function of scanning and reading images of an original sheet and an original book, comprises a scanning optical system 10 having a plurality of reflecting lenses and an imaging member and an ADF (Auto Document Feeder) 9 for automatically feeding an original to a specified place. The original which is automatically fed to an original tray Rt by the automatic document feeder 9 and the image of an original placed on an original table (not shown) are read by the scanning optical system 10.

The image forming unit P has the following function of forming a developer image on a sheet based on the image read by the reading unit R from an original or the image data sent to the image forming apparatus 100 from a peripheral. Moreover, the image forming unit P comprises photosensitive members 2Y-2K, developing rollers 3Y-3K, mixers 4Y-4K, an intermediate transfer belt 6, a fixing apparatus 7 and a discharge tray 8.

A copying processing is roughly described below as an example of a processing carried out by the image forming apparatus 100 provided in the embodiment. First, a sheet picked up by a pickup roller 51 is fed into a sheet conveying path. The sheet fed into the sheet conveying path is conveyed towards a given conveying direction by a plurality of pairs of rollers.

Further, the images of a plurality of sheet originals sequentially and automatically conveyed by the automatic document feeder 9 are read by the scanning optical system 10.

Next, the control board 800 carries out a specific image processing on the image data read by the reading unit R from the original. Then, electrostatic latent images of the data subjected to the image processing are formed on the photosensitive surfaces of photosensitive members 2Y, 2M, 2C and 2K for transferring developer images Y (yellow), M (magenta), C (cyan), K (black)) onto a sheet.

Sequentially, the developer stirred by the mixers 4Y-4K of a developing apparatus is fed, by the developing rollers (the called magnet roller) 3Y-3K, to the photosensitive members 2Y-2K on which electrostatic latent images are formed. In such a manner, the electrostatic latent images formed on the photosensitive surfaces of the photosensitive members are developed.

In this way, the developer images formed on the photosensitive members are transferred to the belt surface of the intermediate transfer belt 6 (the called primary transfer) and conveyed, through the rotation of the intermediate transfer belt, to a given secondary transfer position T to be transferred to the sheet conveyed thereto.

The developer image transferred onto the sheet is thermally fixed by the fixing apparatus 7. The developer images are conveyed in the conveying path by a plurality of conveying rollers through the thermally fixed sheet and then sequentially discharged to the discharge tray 8.

The actions carried out in a printing processing are the same as the actions above except that the data of an object to be printed that is sent from a computer is acquired through a communication I/F 804.

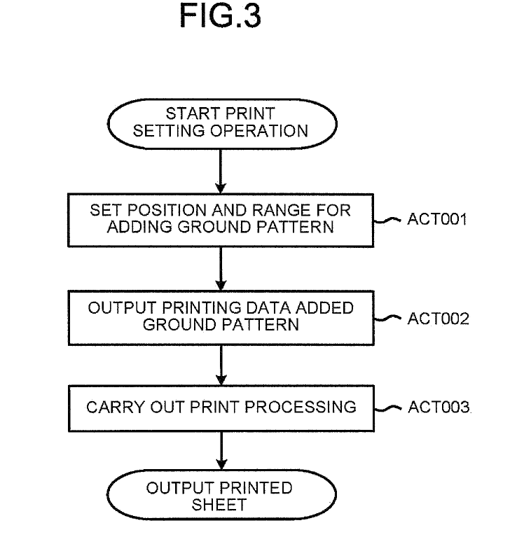

Next, partially add the ground pattern to the sheet is described below with reference to the flowchart of FIG. 3. The processor 211 of the computer 200 calls and executes a print driver when producing an original. The monitor 214 displays a user interface for setting a ground pattern detection range according to an instruction from the processor 211. The user uses the keyboard 215 or a mouse to designate a ground pattern addition range through a coordinate input operation or a drag operation.

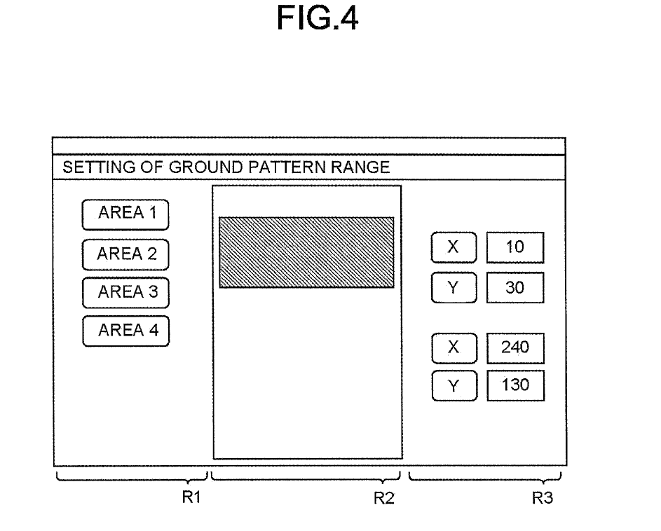

FIG. 4 shows an example of a screen image displayed at this time. The monitor 214 displays the preview image of the object to be printed in a center area R2 and area distribution buttons in a left area R1.

Further, the monitor 214 displays coordinate input boxes in a right area R3. The user presses, for example, the button ‘area 1’ in the area R1, and inputs coordinate values (coordinate X and Y in the top right and in the left lower end) of a ground pattern addition range to each input box in the area R3. In this way, the ‘area 1’ is assigned with the coordinate values and then stored in the memory 212 in association with the coordinate values. In addition, in the area R2, a hatch image corresponding to the coordinate values is overlapped on the preview image and then displayed. The other area buttons in the area R1 are also stored in association with coordinate values, thereby designating a plurality of ranges. Further, the designation on a range may also be realized by dragging the preview image in the area R2 using a mouse.

The processor 211 generates printing data partially added with a specific ground pattern in accordance with the coordinate values obtained and outputs the printing data to the image forming apparatus 100 through the communication I/F 213 (ACT 002). The image forming apparatus 100 forms, using the received printing data, an image on the sheet in the way described in FIG. 2. In this way, a printing sheet partially added with a ground pattern is generated.

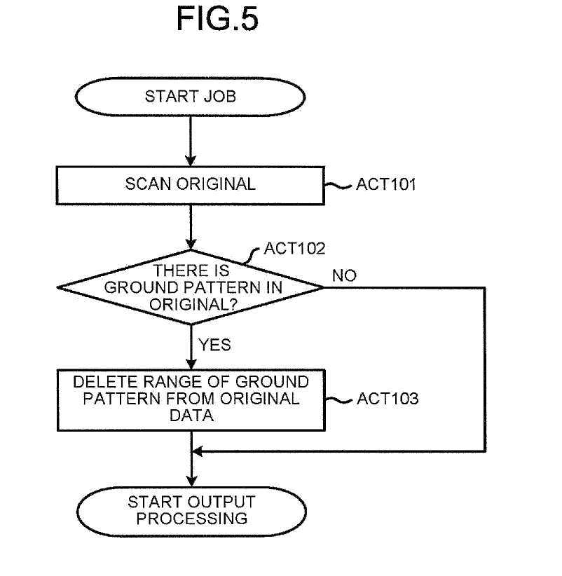

Next, the exemplary actions carried out by the image forming apparatus 100 to print an original sheet partially added with a ground pattern in the way above are described with reference to FIG. 5. In this example, the ground pattern is described as a duplication-prohibited pattern.

The reading unit R of the image forming apparatus 100 scans the original sheet (ACT 101). The control board 800 detects whether or not a specific ground pattern pre-stored in the memory 802 exists in the scanned image (ACT 102). The detection here is utilized by the prior technology of the pattern maching and the like. If there is no ground pattern in the scanned image (ACT 102, No), the detection is ended, and then a normal output processing is carried out.

On the other hand, if there is a ground pattern in the scanned image (ACT 102, Yes), the control board 800 masks or trims the part of the scanned image containing the ground pattern and then edits the masked or trimmed part to be a white blank (in an unrecognized state) (ACT 103). Then, an output processing is carried out. In the output processing, if the function (Job) selected by the user is ‘scan’, the image data is output to the memory 802 or the memory 212 of the computer and then stored. If the Job selected by the user is ‘copy’, the scanned image is formed on the sheet, and if the Job selected by the user is ‘send FAX’, the scanned image is faxed to a destination designated by the user.

By structured like this, the image forming apparatus is capable of copying an original containing duplication-prohibited content after removing the duplication-prohibited content from the original.

Further, a plurality of ground patterns may be stored in the memory 212 of the computer 200 in advance, and a ground pattern corresponding to the position level of the user of the computer 200 is added to an image serving as an object to be printed. By comparing the position level of a logged-in user with the level of the ground pattern, the image forming apparatus 100 determines to set a white blank or to carry out an output processing directly. Below is detailed description.

Image data of a plurality of ground patterns is stored in the memory 212 of the computer 200. Moreover, a table (a first table) consisting of the identification information, the password and the position level information of the user that are associated with each other and a table (a second table) consisting of associated the position level with the ground patterns are stored in the memory 212.

The processor 211 acquires, from the memory 212, the image data of a ground pattern corresponding to the position level of the user of the computer 200 to generate the printing data added to the ground pattern in the way described in FIG. 3.

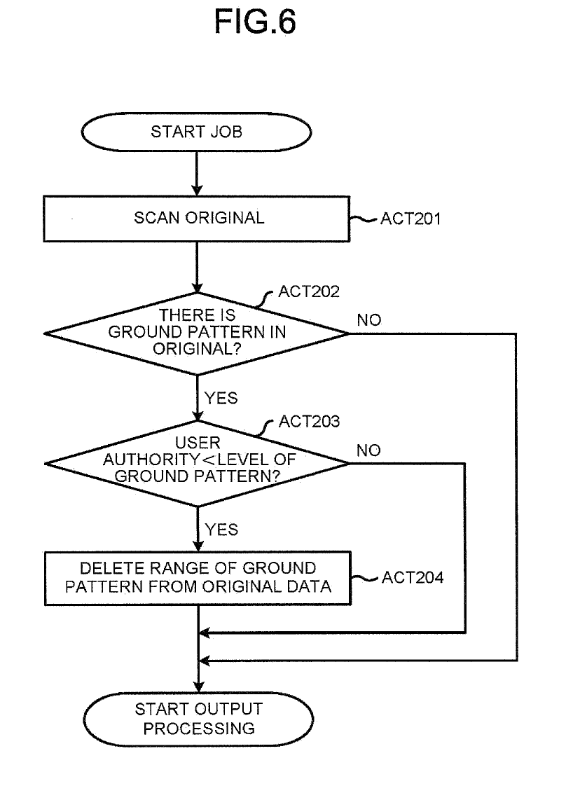

Next, the actions of the image forming apparatus 100 are exemplarily described with reference to FIG. 6. In addition, image data of ground patterns, a first table and a second table are stored in the memory 802 of the image forming apparatus 100, like in the computer 200.

The user is validated when logging into the image forming apparatus 100. Here, the control board 800 acquires the identification information and the password of the user through the control panel 810 to determine whether or not the validation is passed with reference to the first table.

If the validation is passed, the reading unit R scans the original sheet partially added with the ground pattern (ACT 201). The control board 800 determines whether or not there is a ground pattern in the original (ACT 202). If there is a ground pattern in the original, the control board 800 compares the level of the logged-in user with the level of the ground pattern (ACT 203). This processing is described below.

The control board 800 exports the position level of the logged-in user using the first table and the level (position level) of the detected ground pattern using the second table. The control board 800 compares the two levels.

If the position level of the logged-in user is lower (ACT 203, Yes), a white blank processing is carried out on the part added with the ground pattern, and then the processed part is output (ACT 204). On the other hand, if the position level of the logged-in user is higher than the level of the ground pattern (ACT 203, No), the part added with the ground pattern is output directly.

In addition, the validation may be a validation achieved by using an IC card or an external validation using an LDAP (Lightweight Directory Access Protocol). Moreover, tables stored in an external server may be used as the first and second tables.

With the structure above, the part added with a ground pattern cannot be printed by an ordinary clerk but can be printed by a manager, thus, confidential content can be protected by using a document level and a user level.

As an application of this form, all the ground patterns lower in level than the user logging in to the computer 200 may be added when ground patterns are added to generate printing data. For example, when the level of the logged-in user is manager, in addition to the ground pattern corresponding to the level ‘manager’, the ground pattern corresponding to a lower level ‘general clerk’ can certainly also be added. Further, in the case where ground patterns are added to a plurality of parts, ground patterns of different levels can be added to the same sheet.

In the example above, printing data partially added with a ground pattern is generated at the side of the computer 200; however, the data may also be generated at the side of the image forming apparatus 100. The generation of the data at the side of the image forming apparatus 200 is described below. The reading unit R scans original data, and the control panel 810 displays the screen shown in FIG. 4 and displays the scanned image in the area R2. The user designates, using a touch panel, the range to which the ground pattern is added, and presses a given button ‘copy’ after confirming the range. Then, the control board 800 adds a specific ground pattern to the designated range and prints the scanned image onto a sheet. In this way, the copied sheet becomes a sheet partially added with the ground pattern.

The computer 200 is an information processing apparatus, and the image forming apparatus 100 is also an information processing apparatus for executing a processing of, for example, forming printing data on a sheet medium.

The ground pattern is recognizable to human eyes or unrecognizable to human eyes but recognizable to a machine. Moreover, in the embodiment, the part added with a ground pattern is set to be a white blank; however, the same part may be processed optionally as long as the processed part is unrecognizable. For example, the same part may be blacked. Further, position level is described as an example of a user authority in this example, however, the user authority is not limited to this. For example, the user authority may be classified by position or department.

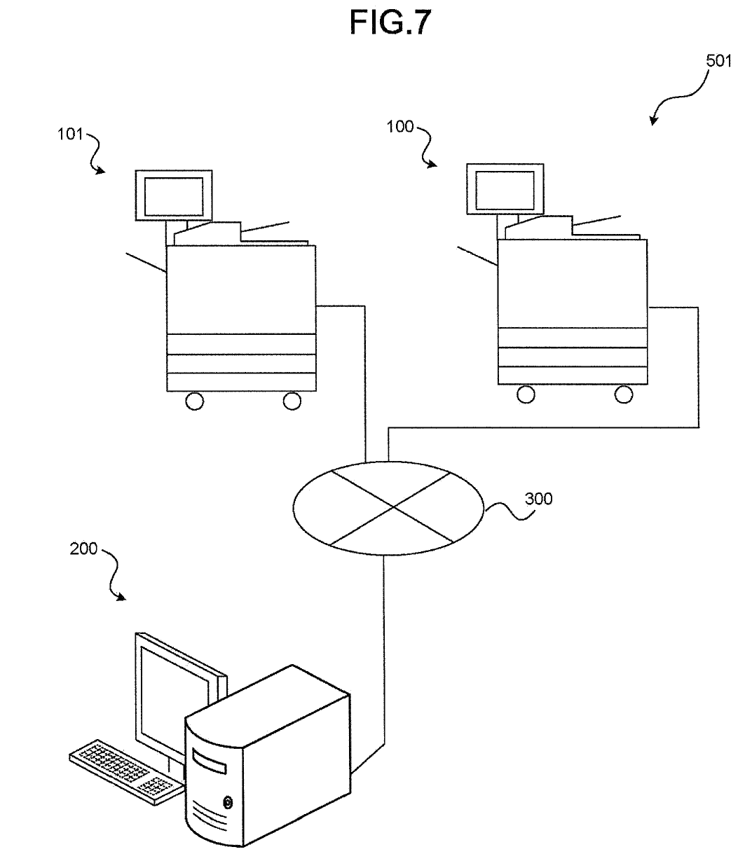

In the description above, by using the image forming apparatus 100 only, a sheet partially added with a ground pattern is generated (a first function), the sheet is scanned, and the part added with the ground pattern is set to be a white blank and then output (a second function). In the system, the first function and the second function may also be achieved by different image forming apparatuses. The system 501 shown in FIG. 7 comprises the image forming apparatus 100 (a second apparatus), the computer 200 (a first apparatus) and an image forming apparatus 101 (a third apparatus) was connected by the network 300. The computer 200 generates printing data partially added with a ground pattern, and the image forming apparatus 100 outputs the printing data. The image forming apparatus 101 scans a sheet and sets the part added with the ground pattern to be a white blank and then outputs the sheet. Further, the functions of the computer 200 may also be achieved by the image forming apparatus 100. Thus, in the system, the first and second functions may be realized by different housings. Further, there may be one or more computers 200, one or more image forming apparatuses 100 and one or more image forming apparatuses 101.

In the embodiment, the functions of the present invention are recorded in the apparatus in advance, however, the present invention is not limited to this, the same functions may also be downloaded to the apparatus from a network or stored in a recording medium and then installed in the apparatus. The recording medium refers to any recording medium (e.g. CD-ROM) that is capable of storing programs and readable to the apparatus. Further, the function achieved by an installed or downloaded program can also be achieved by the cooperation with an OS (Operating System) in the apparatus.

As stated in the detailed description above, according to the technology provided herein, a ground pattern may be added to a part of a sheet but not a whole surface of the sheet. Thus, different processing may be carried out on different parts of a sheet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus, comprising:
a storage unit configured to store a ground pattern;
a display unit configured to display the image of an object to be printed;
an input unit configured to acquire a range information representing partial area of the image displayed by the display unit; and
a control unit configured to add the ground pattern stored in the storage unit to the area of the image and generate a printing data of the image based on the range information acquired by the input unit.

2. The information processing apparatus according to claim 1, wherein
the storage unit stores a plurality of ground patterns corresponding to the level of the user; and
the control unit acquires a ground pattern corresponding to the level of the user of the information processing apparatus from the storage unit and generates a printing data added the ground pattern.

3. The information processing apparatus according to claim 1, wherein
the display unit displays an image representing the range of the image based on the range information acquired by the input unit on the image.

4. An image forming apparatus, comprising:
a storage unit configured to store a ground pattern;
a display unit configured to display the image of an object to be printed;
an input unit configured to acquire a range information representing partial area of the image displayed by the display unit;
a control unit configured to add the ground pattern stored in the storage unit to the area of the image and generate a printing data of the image based on the range information acquired by the input unit; and
an image forming unit configured to form the image added the ground pattern to the area on the sheet according to the printing data generated by the control unit and output the sheet.

5. The image forming apparatus according to claim 4, further comprising:
a reading unit configured to scan the sheet output from the image forming unit to generate the image data drawn on the sheet, wherein
the control unit makes the area added the ground pattern not available for recognition to output the image data generated by the reading unit.

6. The image forming apparatus according to claim 5, wherein
the control unit controls whether or not to make the area added the ground pattern available for recognition by comparing the level of the user of the image forming apparatus with the level based on the ground pattern to output.

7. The information processing apparatus according to claim 4, wherein
the display unit displays an image representing the range of the image based on the range information acquired by the input unit on the image.

8. A system, comprising:
a first apparatus configured to display an image of an object to be printed, acquire a range information representing partial area of the image displayed, and add the ground pattern to the area of the image and generate a printing data of the image based on the range information acquired;
a second apparatus configured to form the image added the ground pattern to the area on the sheet according to the printing data generated by the first apparatus and output the sheet; and
a third apparatus configured to scan the sheet output from the second apparatus to generate the image data drawn on the sheet and make the area added the ground pattern not available for recognition to output the generated image data.

9. The system according to claim 8, wherein
the first apparatus generates a printing data added a ground pattern corresponding to the level of the user of the first apparatus.

10. The system according to claim 9, wherein
the third apparatus controls whether or not to make the area added the ground pattern available for recognition by comparing the level of the user of the third apparatus with the level based on the ground pattern to output.
